(19) United States
(12) Patent Application Publication
(10) Pub. No.: US 2013/0036980 A1
(43) Pub. Date: Feb. 14, 2013

(54) FLOATING INSULATOR ASSEMBLY HAVING CHEW DETERRENT

(71) Applicants: Thomas K. Reusche, Elburn, IL (US); Philip E. Chumbley, Aurora, IL (US)

(72) Inventors: Thomas K. Reusche, Elburn, IL (US); Philip E. Chumbley, Aurora, IL (US)

(73) Assignee: ALLIED PRECISION INDUSTRIES, INC., Elburn, IL (US)

(21) Appl. No.: 13/488,500

(22) Filed: Jun. 5, 2012

Related U.S. Application Data
(60) Provisional application No. 61/515,998, filed on Aug. 8, 2011.

(51) Int. Cl. A01K 29/00; A01K 7/00

(52) U.S. Cl. 119/72; 119/712

(57) ABSTRACT

A floating insulator assembly is configured to be used with a stock tank that is configured to retain water. The assembly may include an insulating member configured to float on water within the stock tank, and a chew deterrent extending from at least a portion of the insulating member. The chew deterrent includes a plurality of chew-deterring protuberances that outwardly extend from at least portion of the insulating member. The chew deterrent is configured to deter an animal from biting or otherwise grasping.

### RELATED APPLICATIONS

The present application relates to and claims priority from U.S. Provisional Application No. 61/515,998, entitled “Anti-Chewing Deterrent For Floating Insulator,” filed Aug. 8, 2011, which is hereby incorporated by reference in its entirety.

### FIELD OF THE INVENTION

Embodiments generally relate to a stock tank configured to retain drinking water for livestock, and, more particularly, to an assembly configured to float on water within the stock tank.

### BACKGROUND OF THE INVENTION

Stock tanks are commonly used to provide drinking water to animals. Generally, stock tanks are located outdoors within a pen where animals are kept. As such, the stock tanks may be exposed to temperature extremes as well as wind, rain, and snow.

Typically, care is taken to ensure that water within a stock tank does not freeze during winter months, as livestock are unable to drink frozen water. Therefore, an electric stock tank de-icer may be used to supply heat to the water within the stock tank.

Many modern stock tank de-icers are thermostatically-controlled to activate when the water temperature approaches freezing and deactivate when the water is heated to a predetermined temperature. The de-icers are typically rated at 1000 watts or more in order to provide enough heat to the tank.

In order for a de-icer to heat the water and then deactivate, heat loss from the stock tank must be less than the heat input from the de-icer. If the heat loss is greater than the heat input, the water will continue to lose heat and will eventually freeze even if the de-icer is running all the time. Because a 1000 watt heater can be expensive to operate continuously, it is desirable to reduce its duty cycle by reducing the heat loss from the water by insulating the tank.

Farmers and ranchers often position a stock tank against a wall of an outbuilding or partially surround the tank with straw bales in order to block the wind. While this is effective in reducing the accelerated heat loss due to wind chill, it does not ameliorate the normal heat loss via convection and radiation.

U.S. Pat. No. 4,100,885 (“Kapplinger”) discloses a specialized stock tank having insulated structural components that are configured to prevent heat loss during the winter. Kapplinger includes a well that extends down into the water as an integral part of the unit. The well is configured to minimize the amount of water that is exposed to the cold air. However, while the specialized stock tank of Kapplinger significantly reduces heat loss, as a specialized tank, it is inapplicable to numerous existing conventional stock tanks.

U.S. Pat. No. 5,921,230 (“Vessells”) discloses an insulating blanket for a hot water heater where the blanket contains piping for circulation of hot waste gases. The blanket disclosed in Vessels forms a part of the heating system itself, and is not a passive insulating device.

U.S. Pat. No. 4,808,356 (“West”) discloses a jacket around a water heater in which expanding foam may be used to fill the intervening space. However, the expanding foam jacket is susceptible to saturation and degradation when exposed to water, thereby adversely affecting the insulating properties.

Other enclosures have been proposed for jacketing hot water heaters. The jacketed hot water heaters are configured to contain water in the event of a leak in the water tank. These jacketed water heaters do not, however, provide thermal insulation in an outdoor environment while providing access to the water.

With respect to swimming pools, for example, in order to reduce heat loss from the water surface, floating insulation is often used. Foam or bubble wrap is often floated on the surface of the water to provide a layer of trapped air thereby significantly reducing heat loss. However, while the water level in a swimming pool stays constant, the water level in a stock tank continually changes.

One known system for insulating a stock tank includes a layer of insulation that floats on the surface of the water within the stock tank. However, various animals, such as horses, view the floating insulation layer and bite or chew the insulation. Indeed, many animals bite into the insulation and remove it from the stock tank.

### SUMMARY OF THE INVENTION

Embodiments provide a system, method, and assembly of preventing animals from biting an insulating layer on or within a stock tank. Embodiments deter animals from chewing or otherwise biting the insulating layer. Embodiments provide an assembly that is configured to discourage an animal from engaging the insulating layer.

Certain embodiments provide a floating insulator assembly configured to be used with a stock tank configured to retain water. The assembly may include an insulating member configured to float on water within the stock tank, and a chew deterrent extending from at least a portion of the insulating member. The chew deterrent may include a plurality of chew-deterring protuberances that outwardly extend from at least portion of the insulating member. The chew deterrent is configured to deter an animal from biting or otherwise grasping.

The chew-deterring protuberances may be or include spikes. Neighboring chew-deterring protuberances may be spaced apart from one another to prevent an animal from engaging the insulating member. For example, neighboring chew-deterring protuberances may be close enough to one another so that an animal may not contact the underlying insulating material.

The chew deterrent may cover an upper surface of the insulating material. The chew deterrent may cover at least one lateral edge of the insulating material. In an embodiment, the chew deterrent may encase the insulating material.

The assembly may also include at least one connection member secured to one or both of the insulating member or the chew deterrent. The connection member may be configured to connect the floating insulator assembly to another floating insulator assembly. The connection member may include at least one connecting strap having a joining member and connection studs.

The chew deterrent may include a base secured to the insulating member. The chew-deterring protuberances may extend outwardly from the base. Optionally, each of the chew-deterring protuberances may include a shaft retained within a passage formed through or within the insulating member.

The insulating member and the chew deterrent may be integrally molded and formed together as a single piece. For example, a single mold may be used to produce a unitary assembly. The assembly may be formed through injection molded plastic that is configured to be buoyant.

The insulating member may be formed of a buoyant material including one or more of closed-cell foam, an inflatable air bladder, rubber, or bubble wrap.

Certain embodiments provide a system for providing water to livestock. The system may include a stock tank including a base integrally formed with a retaining wall, wherein a water-retaining cavity is defined between the base and the retaining wall. The water-retaining cavity is configured to retain water for the livestock to drink. The system may also include a floating insulator assembly configured to float on water within the water-retaining cavity and insulate the stock tank, the floating insulator assembly may include an insulating member configured to float on water within the stock tank, and a chew deterrent extending from at least a portion of the insulating member. The chew deterrent may include a plurality of chew-deterring protuberances that outwardly extend from at least a portion of the insulating member. The chew deterrent is configured to deter an animal from biting or otherwise grasping.

### BRIEF DESCRIPTION OF SEVERAL VIEWS OF THE DRAWINGS

FIG. 1 illustrates a cross-sectional view of a stock tank.

FIG. 2 illustrates a cross-sectional view of a stock tank.

FIG. 3 illustrates a cross-sectional view of a stock tank.

FIG. 4 illustrates an end view of a floating insulator assembly, according to an embodiment.

FIG. 5 illustrates an end view of a floating insulator assembly, according to an embodiment.

FIG. 6 illustrates a top plan view of a floating insulator assembly, according to an embodiment.

FIG. 7 illustrates an end view of a floating insulator assembly, according to an embodiment.

FIG. 8 illustrates an end view of a floating insulator assembly, according to an embodiment.

FIG. 9 illustrates a top plan view of a stock tank having a floating insulator assembly, according to an embodiment.

FIG. 10 illustrates a top plan view of a stock tank having a floating insulator assembly, according to an embodiment.

The foregoing summary, as well as the following detailed description of certain embodiments of the present invention, will be better understood when read in conjunction with the appended drawings. For the purpose of illustrating the invention, there are shown in the drawings, certain embodiments. It should be understood, however, that the present invention is not limited to the arrangements and instrumentalities shown in the attached drawings.

### DETAILED DESCRIPTION OF THE INVENTION

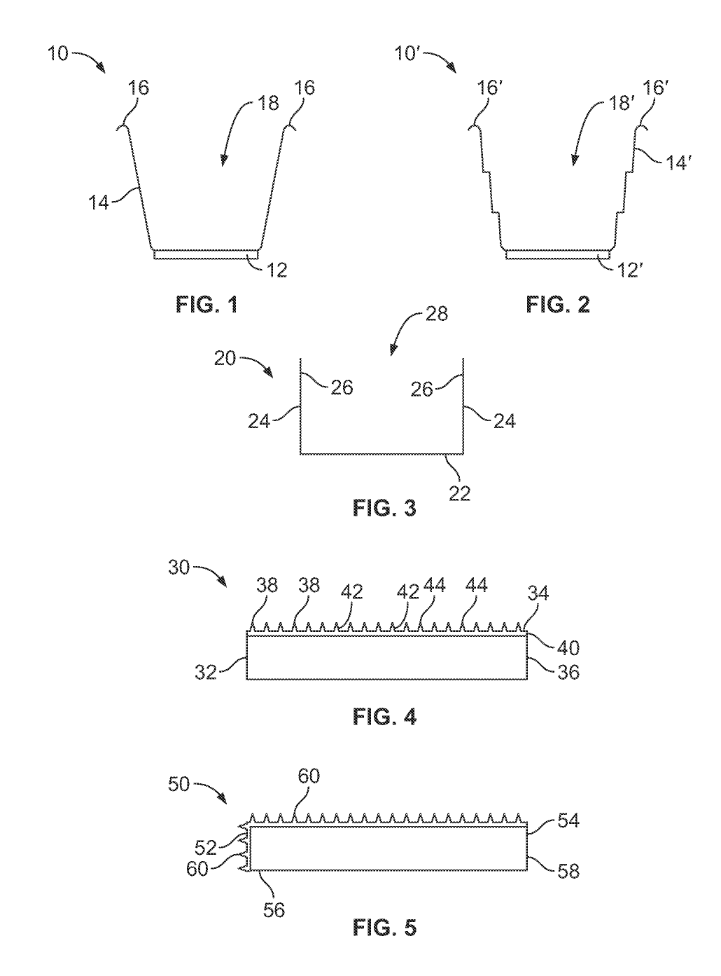

FIG. 1 illustrates a cross-sectional view of a stock tank 10. FIG. 2 illustrates a cross-sectional view of a stock tank 10′. As shown in FIGS. 1 and 2, the stock tanks 10 and 10′ are defined by a base 12 and 12′, respectively, integrally connected to retaining walls 14 and 14′, respectively. Upper ends of the retaining walls 14 and 14′ terminate in rounded lips 16 and 16′, respectively.

The walls 14 of the stock tank 10 taper downward from the lip 16 to the base 12. The walls 14′ of the stock tank 10′ step down from the lip 16′ to the base 12′.

A water-retaining cavity 18 is defined between the walls 14 and the base 12. Similarly, a water-retaining cavity 18′ is defined between the walls 14′ and the base 12′. The water-retaining cavities 18 and 18′ are configured to retain water for animals to drink.

FIG. 3 illustrates a cross-sectional view of a stock tank 20. The stock tank 20 also includes a base 22 integrally connected to upstanding retaining walls 24, which may be generally perpendicular to the base 22. Exposed ends 26 of the retaining walls 24 may or may not include rounded lips, such as shown in FIGS. 1 and 2. A water-retaining cavity 28 is defined between the walls 24 and the base 22.

Embodiments may be used with various types of stock tanks, and various types of floating insulator assemblies, such as shown and described in United States Patent Application Publication No. 2011/0107974, entitled “System and Method of Insulating a Stock Tank,” filed Oct. 18, 2010, which is hereby incorporated by reference in its entirety.

FIG. 4 illustrates an end view of a floating insulator assembly 30, according to an embodiment. The assembly 30 includes an insulating layer or member 32 and a chew deterrent 34 extending outwardly from the insulating member 32.

The insulating member 32 is configured to float on a surface of water within a stock tank, such as any of the stock tanks described above. To that end, the insulating member 32 may be or include a layer of buoyant material, such as an air-filled bladder, closed-cell foam, bubble wrap, Styrofoam, rubber, or various other materials and substance that float on water. The insulating member 32 generally includes a flexible, buoyant layer 36 that is sized and shaped to fit within at least a portion of a stock tank.

The chew deterrent 34 may be supported on the buoyant layer 36. The chew deterrent 34 includes chew-deterring protuberances 38 extending outwardly therefrom. The chew-deterring protuberances 38 may be supported by a base 40 that is secured on the buoyant layer 36. Optionally, the chew-deterring protuberances 38 may directly connect and extend outwardly from the buoyant layer 36 without the base 40. Alternatively, the chew deterrent may be part of the buoyant layer 36 itself. For example, the buoyant layer 36 may include outwardly-directed chew-deterring protuberances 38.

Each chew-deterring protuberance 38 may include a stem 42 integrally connected to a sharp-tipped point 44. The stem 42 progressively narrows toward the point 44, which provides a sharp tip configured to deter an animal from engaging. The chew-deterring protuberances 38 may be or include spikes, needles, nails, or other such sharp pointed objects with the sharp-tipped points 44 exposed at outward ends. The chew-deterring protuberances 38 may be formed of plastic or metal, and may be integrally formed with the base 40. Optionally, the chew-deterring protuberances 38 may be separate and distinct from the base 40.

The sharp-tipped points 44 of the chew-deterring protuberances 38 are configured to deter an animal from engaging. For example, an animal will discover that the sharp-tipped points 44 are unpleasant to the touch. The sharp-tipped points 44 may inflict a small degree of pain if grasped by an animal. While the pain inflicted will not cause injury, the pain will prevent the animal from re-engaging the sharp-tipped points 44.

The chew-deterring protuberances 38 may be spaced evenly over a surface of the chew deterrent 34. The chew-deterring protuberances 38 may be spaced apart from one another such that an animal may not engage its mouth around any of the stems 42. For example, the chew-deterring protuberances 38 may be spaced less than one inch from neighboring chew-deterring protuberances 38. Alternatively, the chew-deterring protuberances 38 may be spaced at greater distances from one another.

The chew deterrent 34 may be secured to the insulating member 32 through various fasteners. For example, the base 40 of the chew deterrent 34 may be adhesively bonded over the insulating member 32. The chew deterrent 34 may be glued to the insulating member 32. Optionally, the base 40 and the insulating member 32 may be integrally molded and formed as a single unit with protuberance-retaining cavities formed therein. In this embodiment, the chew-deterring protuberances 38 may be individually positioned and secured within the protuberance-retaining cavities after the base 40 and the insulating member 32 have been formed. Moreover, instead of using a base 40, protuberance-retaining cavities may be formed directly in the insulating member 32, and the chew-deterring protuberances 38 may be individually positioned and secured within the cavities after the insulating member 32 is formed.

Additionally, alternatively, the chew deterrent 34 may snapably, latchably, or otherwise removably secure to the insulating member 32. In this embodiment, an underside of the chew deterrent 34 may include features, such as tabs, slots, barbs, posts, snap-features, or the like, that align with reciprocal features on the insulating member 32. In order to secure the chew deterrent 34 to the insulating member 32, the chew deterrent 34 may simply be urged into the insulating member 32, with an audible snap, click, or the like indicating that the chew deterrent 34 has been securely snapped, latched, or the like to the insulating member 32.

While the chew deterrent 34 is shown on top of the insulating member 32, the chew deterrent 34 may overlay other portions of the insulating member 32, as well. For example, the chew deterrent 34 may wrap around front, rear, and lateral edges of the insulating member 32. Moreover, the chew deterrent 34 may wrap around an entire outer surface of the insulating member 32. In this embodiment, the chew deterrent 34 may encase the insulating member 32.

FIG. 5 illustrates an end view of a floating insulator assembly 50, according to an embodiment. The assembly 50 is similar to the assembly 30 shown in FIG. 4, except that a chew deterrent 52 covers a top surface 54 and a lateral edge 56 of an insulating layer 58. As noted above, the chew deterrent 52 may cover additional exposed surfaces of the insulating layer 58. Indeed, the chew deterrent 52 may encase the insulating layer 58. By wrapping the chew deterrent 52 over the lateral edge 56, the chew-deterring protuberances 60 prevent an animal from grasping a lateral lip, as well as the top surface 54 of the insulating later 58.

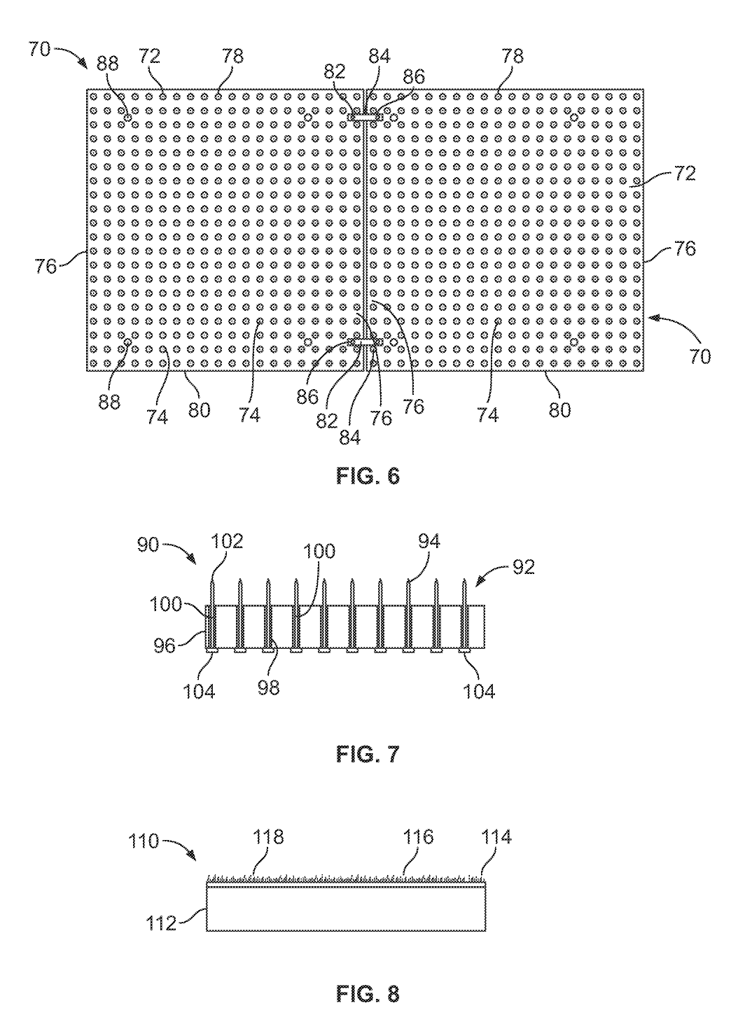

FIG. 6 illustrates a top plan view of a floating insulator assembly 70, according to an embodiment. The assembly 70 includes an insulating member (hidden from view), such as described above, and chew deterrent 72 having multiple chew-deterring protuberances 74, such as described above. The floating insulator assembly 70 includes lateral edges 76 integrally connected to top and bottom edges 78 and 80, respectively. As shown in FIG. 6, the floating insulator assembly 70 may be square or rectangular. However, the assembly 70 may be various other shapes and sizes. The assembly 70 may be sized and shaped to fit within a particular stock tank.

As shown, the assembly 70 may be modular. One assembly 70 may secure to another assembly 70 through connecting straps 82. Each connecting strap 82 may include a joining member 84, such as a strap, beam, ribbon, or the like having downwardly-extending connection studs 86 at opposite ends. The connection studs 86 are configured to be received and retained within reciprocal cavities 88 formed within the chew deterrent 72. For example, one connection stud 86 may be secured within a cavity 88 of a first assembly 70, while the opposed connection stud 86 may be secured within a cavity 88 of a second assembly 70. The joining member 84 then connects the first and second assemblies 70 together. As shown in FIG. 6, the cavities 88 may be positioned at various points proximate the outer edges of the assemblies 70. As such, more assemblies 70 may be secured thereto.

Alternatively, instead of connecting straps 82, the assemblies 70 may be connected together through various other systems and methods. For example, the assemblies may include strings extending from outer edges. The strings from separate and distinct assemblies may be tied together to secure the assemblies 70 together. Additionally, the connecting members, whether strings, straps 82, tab and slot members, snap fit members, or the like, may be above or below the exposed surface of the chew deterrent 72. Further, the connecting members may extend from terminal edge portions of the chew deterrent 72.

FIG. 7 illustrates an end view of a floating insulator assembly 90, according to an embodiment. The insulator assembly 90 includes a chew deterrent 92 having multiple chew-deterring protuberances 94 that extend through an insulating layer 96. The insulator assembly 90 may include multiple passages 98 that receive and retain shafts 100 of the chew-deterring protuberances 94. The shafts 100 connect to distal sharp-tipped points 102 that are exposed over the insulating layer 96. Connection bases 104 connected to the shafts 100 at opposite ends from the sharp-tipped points 102 have diameters that are larger than the diameters of the passages 98, and are therefore prevented from passing therein. The connection bases 104 and/or the shafts 100 may be secured to the insulating layer 96 through adhesives, for example. Optionally, instead of individual connection bases 104, a contiguous, planar base may connect to all of the shafts 100.

As mentioned above, the insulating layer 96 may be an air-filled bladder, for example. The insulating layer 96 may include an air-tight rubber or plastic outer layer defining an internal chamber that is inflated with air. The passages 98 do not puncture the rubber or plastic outer layer. Instead, the outer layer may be formed to accommodate the passages 98. Optionally, as noted above, the insulating layer 96 may be formed of a closed cell foam, solid rubber, bubble wrap, or various other materials that provide an insulating, buoyant layer.

FIG. 8 illustrates an end view of a floating insulator assembly 110, according to an embodiment. The assembly 110 includes an insulating member 112, as described above, with a chew deterrent 114 overlaying at least a portion of the insulating member 112. The chew deterrent 114 may include a protuberance member 116, which may be or include a carpet, sheet, coating, or the like, having multiple chew-deterring protuberances 118 extending outwardly therefrom. The protuberances 118 may be needlelike protrusions. As noted above, the chew deterrent 114 may extend over more or less portions of the insulating member 112 than shown in FIG. 8.

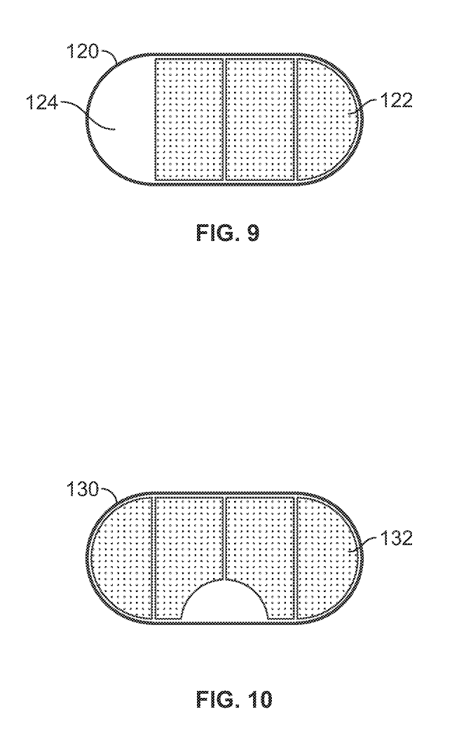

FIG. 9 illustrates a top plan view of a stock tank 120 having a floating insulator assembly 122, according to an embodiment. The floating insulator assembly 122 may be any of the floating insulator assemblies described above with respect to FIGS. 4-8. The floating insulator assembly 122 may be a single assembly sized and shaped to fit a portion of the stock tank 120. Optionally, the floating insulator assembly 122 may include multiple modular assemblies connected together, as described above with respect to FIG. 6, for example. The floating insulator assembly 122 may not cover the entirety of the water within the stock tank 120. As such, an opening 124 exposes water within the stock tank 120. In this manner, an animal may drink water from the stock tank 120 through the opening 124.

FIG. 10 illustrates a top plan view of a stock tank 130 having a floating insulator assembly 132, according to an embodiment. The floating insulator assembly 132 may be any of the floating insulator assemblies described above with respect to FIGS. 4-8. The floating insulator assembly 132 may be a single assembly sized and shaped to fit a portion of the stock tank 130. Optionally, the floating insulator assembly 132 may include multiple modular assemblies connected together, as described above with respect to FIG. 6, for example. The floating insulator assembly 132 may not cover the entirety of the water within the stock tank 130. As such, an opening 134 may be formed within the floating insulator assembly 132. The opening 134 may be sized and shaped to accommodate the head of an animal. The opening 134 exposes water within the stock tank 120. In this manner, an animal may drink water from the stock tank 130 through the opening 134. The opening 134 may be a void or cutout within the assembly 132. Optionally, the assembly 132 may include a flap section configured to be folded back to provide the opening 132.

Referring to FIGS. 4-10, a chew deterrent may cover an entire surface of an insulating material. Optionally, the chew deterrent may cover only a portion of the insulating material. For example, the chew deterrent may cover less than an entire upper surface of the insulating material. The chew deterrent may extend proximate and around only edge portions of the insulating material, for example. Moreover, the floating insulator assembly may be sized and shaped to float over only a portion of water within a stock tank. For example, the floating insulator assembly may be sized and shaped as an annular tube member that floats over water proximate to interior wall portions of the stock tank, with a central opening formed through the floating insulator assembly.

The chew deterrent of any of the embodiments may be formed from a solid, opaque material, such as metal or plastic. Accordingly, the chew deterrent may protect the insulating material from ultra-violet radiation.

As described and shown, embodiments provide a system, method, and assembly of preventing animals from biting an insulating layer on or within a stock tank. Embodiments deter animals from chewing or otherwise biting the insulating layer. Embodiments provide an assembly that is configured to discourage an animal from engaging the insulating layer with its mouth.

While various spatial terms, such as upper, bottom, lower, mid, lateral, horizontal, vertical, and the like may be used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A floating insulator assembly configured to be used with a stock tank configured to retain water, the assembly comprising:
an insulating member configured to float on water within the stock tank; and
a chew deterrent extending from at least a portion of the insulating member, wherein the chew deterrent includes a plurality of chew-deterring protuberances that outwardly extend from at least a portion of the insulating member, and wherein the chew deterrent is configured to deter an animal from biting or otherwise grasping.

2. The assembly of claim 1, wherein each of the chew-deterring protuberances comprises a spike.

3. The assembly of claim 1, wherein neighboring ones of the plurality of chew-deterring protuberances are spaced apart from one another to prevent an animal from engaging the insulating member.

4. The assembly of claim 1, wherein the chew deterrent covers an upper surface of the insulating material.

5. The assembly of claim 2, wherein the chew deterrent covers at least one lateral edge of the insulating material.

6. The assembly of claim 1, wherein the chew deterrent encases the insulating material.

7. The assembly of claim 1, further comprising at least one connection member secured to one or both of the insulating member or the chew deterrent, wherein the at least one connection member is configured to connect the floating insulator assembly to another floating insulator assembly.

8. The assembly of claim 1, wherein the at least one connection member comprises at least one connecting strap having a joining member and connection studs.

9. The assembly of claim 1, wherein the chew deterrent comprises a base secured to the insulating member, wherein the chew-deterring protuberances extend outwardly from the base.

10. The assembly of claim 1, wherein each of the chew-deterring protuberances comprises a shaft retained within a passage formed through or within the insulating member.

11. The assembly of claim 1, wherein the insulating member and the chew deterrent are integrally molded and formed together as a single piece.

12. The assembly of claim 1, wherein the insulating member is formed of a buoyant material including one or more of closed-cell foam, an inflatable air bladder, rubber, or bubble wrap.

13. A system for providing water to livestock, the system comprising:
a stock tank including a base integrally formed with a retaining wall, wherein a water-retaining cavity is defined between the base and the retaining wall, and wherein the water-retaining cavity is configured to retain water for the livestock to drink; and
a floating insulator assembly configured to float on water within the water-retaining cavity and insulate the stock tank, the floating insulator assembly comprising:
an insulating member configured to float on water within the stock tank; and
a chew deterrent extending from at least a portion of the insulating member, wherein the chew deterrent includes a plurality of chew-deterring protuberances that outwardly extend from at least a portion of the insulating member, and wherein the chew deterrent is configured to deter an animal from biting or otherwise grasping.

14. The system of claim 13, wherein each of the chew-deterring protuberances comprises a spike.

15. The system of claim 13, wherein neighboring ones of the plurality of chew-deterring protuberances are spaced apart from one another to prevent an animal from engaging the insulating member.

16. The system of claim 13, wherein the chew deterrent covers an upper surface of the insulating material.

17. The system of claim 13, wherein the chew deterrent covers at least one lateral edge of the insulating material.

18. The system of claim 13, wherein the chew deterrent encases the insulating material.

19. The system of claim 13, wherein the floating insulator assembly further includes at least one connection member secured to one or both of the insulating member or the chew deterrent, wherein the at least one connection member is configured to connect the floating insulator assembly to another floating insulator assembly.

20. The system of claim 13, wherein the insulating member is formed of a buoyant material including one or more of closed-cell foam, an inflatable air bladder, rubber, or bubble wrap.
